(19) United States
(12) Patent Application Publication
(10) Pub. No.: US 2024/0078279 A1
(43) Pub. Date: Mar. 7, 2024

(54) METHOD AND SYSTEM TO MAKE WEBSITES ACCESSIBLE TO PEOPLE WITH HEARING IMPAIRMENTS

(71) Applicant: INKLUSION AMERICA LLC, Tucson, AZ (US)

(72) Inventors: Rafael Juan Millan Harfuch, Mexico City (MX); Rodrigo García Madrazo, Mexico City (MX)

(21) Appl. No.: 17/929,065

(22) Filed: Sep. 1, 2022

(51) Int. Cl. G06F 16/957; G09B 21/00

(52) U.S. Cl. CPC G06F 16/957; G09B 21/00

(57) ABSTRACT

The present invention relates to an apparatus, method and system for making web pages accessible to users with some type of hearing disability using sign language associated with a geolocated region from where a user accesses a URL site. The method comprises the steps of: receiving an input language in the form of text or words to be transformed into an output language in visual form; transmitting the input language to a web server coupled to a knowledge database comprising a plurality of dictionaries according to the language of the URL site and the sign language related to said language to interpret the input language to the output language; and reproducing the output language in the form of a video clip. The system of the present invention comprises at least one electronic device in communication with a web server coupled to a knowledge database to interpret words/text into sign language. As a result, users with hearing disabilities can access information that they would otherwise not be able to consult, without the need to use devices or equipment other than conventional ones, thus improving their quality of life.

### FIELD OF THE INVENTION

This invention refers to methods, devices and systems to make websites accessible to people with a hearing disability who communicate through sign language associated with a geolocated region.

### BACKGROUND OF THE INVENTION

Currently, many websites and tools are developed such that they include accessibility barriers that make their use difficult or impossible for people with disabilities, and more specifically, for people with hearing disabilities. Making the web accessible benefits individuals, companies and society in general, since it guarantees that people with disabilities can access services, information, content, digital media and even purchase goods or services online. In the United States alone, according to information from the National Institute on Deafness and other Communication Disorders (NIDCD) updated in 2021, around 15% of adult Americans (37.5 million people) report some kind of hearing problem. Therefore, the implementation of suitable methods to achieve web accessibility constitutes the protection of the human rights of people with disabilities, by eliminating physical and social barriers and facilitating access, communication, free knowledge and a better use of new technologies to this particularly vulnerable population group. The web pages of public entities must be accessible and usable by people with different types of disabilities in accordance with international standards and must be adapted to keep up with changes in technology.

In the state of the art there are some solutions to the above problem specifically focused on hearing impairment and using sign language, as detailed below.

Document EP2237243A1 refers to a method of obtaining data related to an area of the electronic page by an obtaining unit, and the production of a video in sign language corresponding to the area of the electronic page by the obtaining unit. The area is detected by a detection unit based on cursor movements on a terminal screen, e.g., a mobile terminal. An electronic page is sent to the terminal, where the electronic page has codes detected at the terminal. The main objective of this document is to remedy the disadvantages of the prior art, which does not allow the user to obtain the context, making it more difficult to understand the content. This is achieved thanks to a step of obtaining at least one piece of data associated with said area, said area having been detected based on movements of a cursor, such step being performed before the step of obtaining a video. Said at least one piece of data associated with said area is, for example, an identifier of this area, or a text to be translated associated with this area, this data being intended to allow a device implementing the invention to obtain a text to translate in connection with this area.

Document US20020032702A1 relates to an image display method and apparatus for displaying images (for example, moving images) corresponding to voice data or document data, and more particularly to an image display method and apparatus capable of displaying images in sign language corresponding to speech. The image display apparatus comprises image storage means for storing image data, storage means for storing document data, reading means for reading document data stored in the storage means and reading image data corresponding to a string of characters of the document data from the image storage means and display means for displaying the image data read by the reading means.

US20040218451A1 discusses an accessible user interface and navigation system and method comprising: accessing a manageable subset of basic functions needed by a disabled user to access information; choosing specific features that match that user's disability; and selecting an accessible user interface tailored to said user's disability to enable said user to access the information.

U.S. Pat. No. 8,566,075B1 provides a text to sign language translation platform as well as a method implemented by a processor to translate information comprising: receiving a textual voice input element; translating the textual word input element using predefined selection modification criteria; querying a motion picture database for a motion picture corresponding to the translated textual voice input item; selecting from the moving picture database at least one sign language target picture clip based on the translation of the textual word input element and output the at least one sign language target picture clip to a sign language display device.

Despite the previous efforts, there is still a need for technologies that facilitate web access for people with hearing disabilities through the use of sign language that, on the user's side, break the communication and learning barrier these people experience, and that are simple to use, intuitive, efficient (without the use of avatars or letter-by-letter interpretation of the alphabet) and that comply with the good practices set forth in the Web Accessibility Initiative (WAI) and the World Wide Web Consortium (W3C) and, on the provider's side, that are easy to implement within the regular version of a website and that are not invasive with the source code of the portal or website incorporating them.

These and other advantages of the present invention will become apparent from the following description and figures.

### BRIEF DESCRIPTION OF THE INVENTION

The present invention relates to an apparatus, method and system for making web pages accessible to users with some type of hearing disability using sign language associated with a geolocated region from where a user accesses a URL site.

In the preferred embodiment, the method comprises the steps of a) receiving an input language to be transformed into an output language in visual form by an input device, wherein the input language is in the form of text or words and wherein the input device is preferably a mouse; b) transmitting the input language to a web server coupled to a knowledge database comprising a plurality of dictionaries according to the language of the URL site and the sign language related to said language to interpret the input language to the output language; and c) reproducing the output language (sign language), preferably a video clip showing a human being (not an avatar) interpreting the sign language so that the interpretation is more natural to the user. Said video clip can be, for example, in gif format. The web server of the system of the present invention is of the ICAP (Internet Content Adaptation Protocol) type and, as stated above, is coupled to a knowledge database of the language of the URL site accessed by the user and of the sign language related to that language, according to the region geolocated by the system; said knowledge database is autonomously enriched by means of an artificial intelligence module comprising a neural-type network, which analyzes and interprets the information from previous visits to said URL site, according to the main theme of the URL site, to then collect such information in the plurality of dictionaries of the knowledge database and enrich said base. Thanks to the above, the interpretation is more precise, since it takes into account the context of the information.

In order to operate, the system of the present invention requires at least one electronic device with a network connection. From said device, the user with a hearing disability accesses any URL provided with the method of the present invention and can transform words or text present in the URL site into sign language, allowing the user to access information or content that they otherwise would not be able to consult, thus improving their quality of life.

### BRIEF DESCRIPTION OF THE FIGURES

FIG. 1 is a schematic diagram of the method of the present invention.

FIG. 2 is a block diagram illustrating one embodiment of the system according to the present invention.

FIG. 3 is a flowchart that illustrates the steps of the method of the present invention.

FIG. 4 is an exemplary illustration of a screenshot of a web page implementing the method of the present invention.

FIG. 5 is an exemplary illustration of a screenshot of the help page displayed within a web page implementing the method of the present invention.

### DETAILED DESCRIPTION OF THE INVENTION

### Definitions

Device or electronic apparatus: Any type of mobile device such as, for example, a smartphone, a mobile computer, a personal digital assistant (PDA), a tablet, a smartwatch or any other electronic “smart device”.

Network Connection: The processing and transmission of data (a bitstream) over a point-to-point or point-to-multipoint communication channel by means of wired or wireless connections through WAN-, MAN- and/or LAN-type networks, wherein, in one embodiment, the WAN connection can be the Internet. This network connection must be compatible with the most common communication protocols for the exchange of information between the different components of the system, for example, Hypertext Transfer Protocol (HTTP) and Hypertext Transfer Protocol Secure (HTTPS).

Graphical User Interface (GUI): A user interface that includes graphical elements, such as windows, icons, and buttons. Applications are generally provided with GUIs to allow users to use the applications.

Web service: A software system designed to support machine-to-machine interaction, through a network, in an interoperable way. It has an interface described in a format that can be processed by a computer, through which interactions are possible by exchanging SOAP messages, typically transmitted using XML serialization over HTTP together with other web standards.

URL (Uniform Resource Locator): The unique and specific address of each page or resource that exists on the web. Each page, each resource, is linked to a URL. Throughout the description, the terms URL or website are used interchangeably.

Software as a Service (SaaS): An application solution hosted and maintained by a third party in the cloud.

On-Premise—This is a system that is hosted locally on the customer's own system and backed up by a third party to provide support should problems arise.

Web browser: An application that allows access to the Web, interpreting information from different types of files and websites so that they can be viewed, the most common being Mozilla Firefox, Google Chrome, Microsoft Edge and Safari. Websites that implement the present invention must be compatible at least with the latter.

Service layer: In software programming architecture, this is the layer holding the libraries, services and protocols that are implemented in the system. This is where user requests are received and responses are sent after the process.

The term “a plurality” used throughout this description refers to a large number of elements that generally ranges from 2 to 500, but can cover a greater number.

The term “at least” used throughout this description indicates a minimum value or lower limit for the element to which it refers.

The following detailed description may indistinctly refer to the figures.

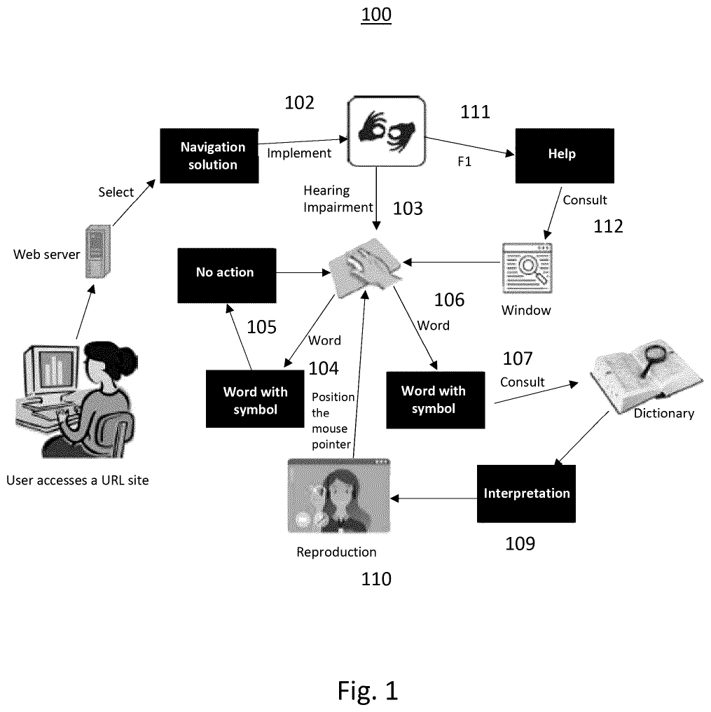

FIG. 1 illustrates a simplified diagram of the method for making websites accessible to people with hearing disabilities.

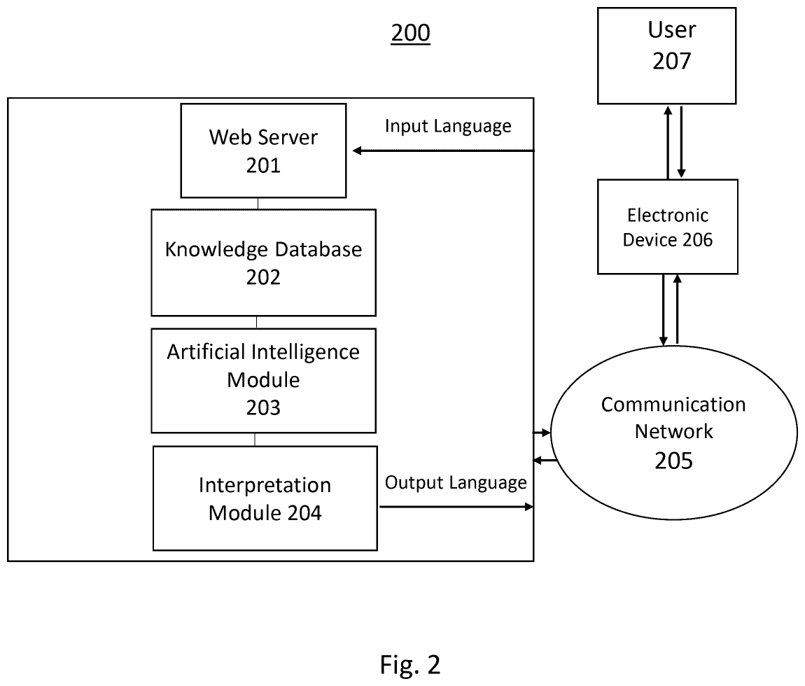

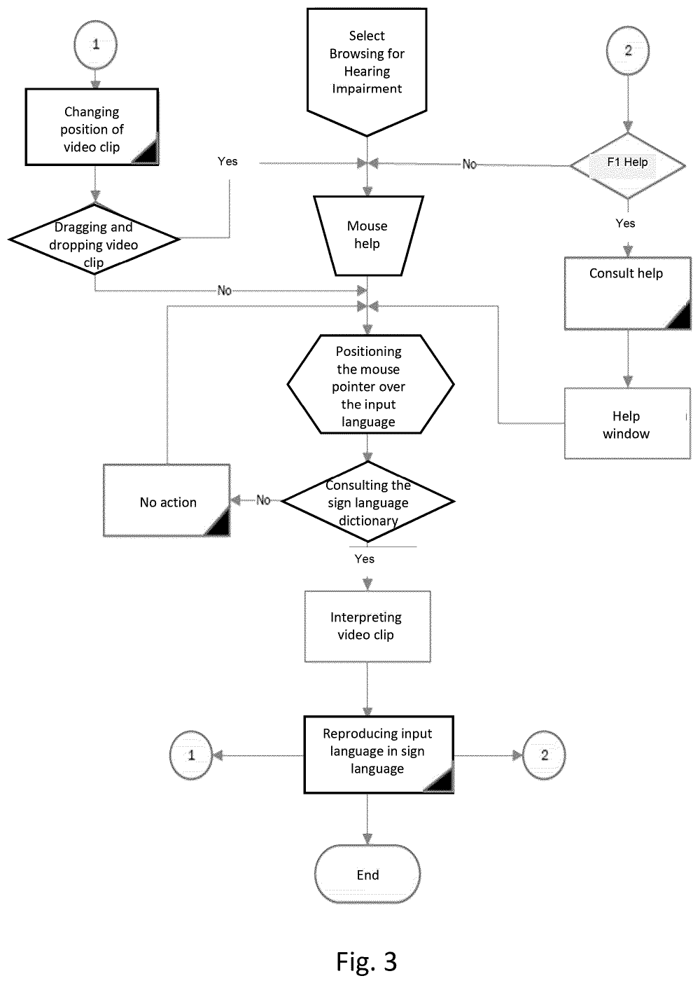

According to the illustrated embodiment (FIGS. 1 to 3), to implement the method 100, a user 207, preferably a person with any degree of hearing impairment, accesses 102 a URL provided with the method of the present invention to transform an input language into an output language using an electronic device or apparatus 206 that has access to a communication network 205 via a network connection. Said electronic device 206 can include, in its most basic configuration, a processing unit, a memory, a communication interface and an input/output interface; said input/output interface may include, but is not limited to, a screen, a mouse, a microphone, a camera, a keyboard, etc. Depending on the exact configuration and type of computing device, the memory can be volatile (such as random access memory [RAM], nonvolatile (such as read-only memory [ROM], flash memory, etc.), or a combination of the two. The communication interface allows the electronic device 206 to communicate with other devices, such as smartphones, laptops, desktop computers and the like.

In the preferred embodiment of the invention, the input language is in the form of text or words and the output language is a visual language, preferably sign language related to the web page language, which are identified by geolocation of the region from where the site in question is visited.

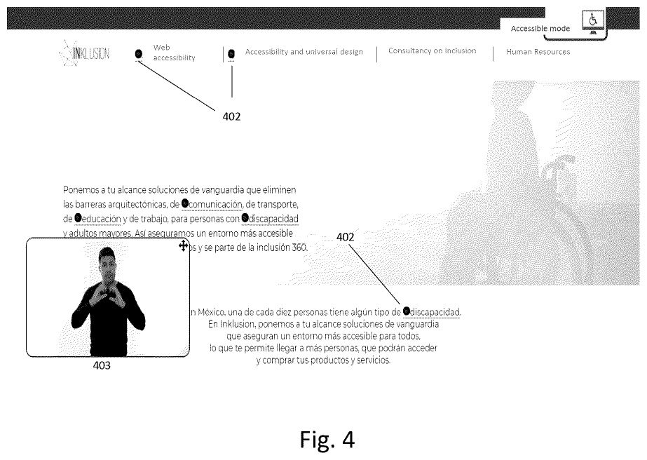

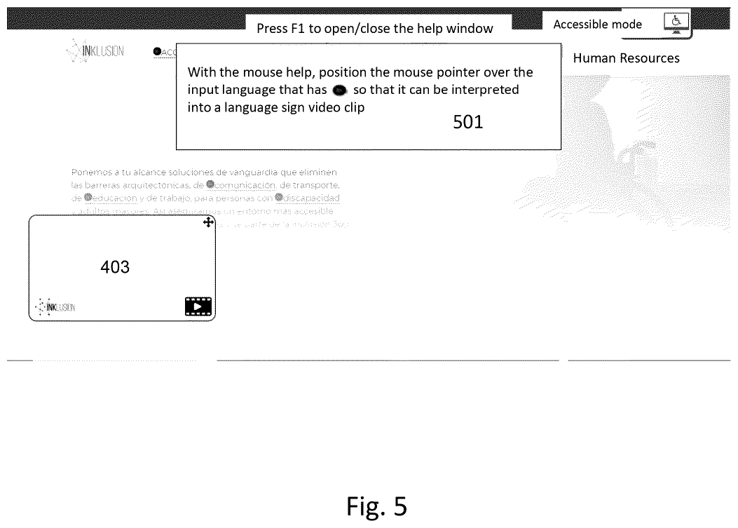

To perform the input language transformation, the user 207 must use an input device 103, for example, a mouse, alphanumeric keyboard, joystick, touchpad, light pen, or any similar device, to select the text 106 to be transformed by the system 200 into an output language. In the illustrated embodiment of the invention, the input device 103 is a mouse and the user 207 selects the input language by positioning the mouse pointer over said input language 106. In one embodiment of the invention, a graphical interface associated with the system 200 will display an element, for example, a triangle icon 402 in the illustrated embodiment, typically the icon indicating “video playback”, over the text with the sign language interpretation option, as shown in FIGS. 4 and 5. It is worth mentioning that when the user 207 selects a word or text 104 that the previous icon does not understand, the system 200 will not perform any action 105 and the text will not be transformed.

To perform the language transformation, the system 200 comprises an ICAP (content adaptation protocol) type web server 201 coupled to a knowledge database 202 of the language of the URL site and of the sign language related to that language, according to a region geolocated by the server 201. To carry out said geolocation, a service layer of the system 200, through origin connection trackers, allows identifying the point (region) from where the user makes the request, which in turn allows selecting the language and dictionaries to apply.

When the user 207 selects the input language with the help of the input device 103, the system 200 consults 107 said knowledge database 202 to interpret it 109 in an interpretation module 204 to the corresponding output language and, finally, reproduce it 110 in an output device, e.g., a screen, which may be from the same electronic device 206 or from any other device. In a preferred embodiment of the invention, the knowledge database 202 comprises a plurality of dictionaries and the output language is reproduced in the form of a video clip 403, for example in GIF format, which is displayed on the screen of the electronic device 206. Preferably, the video clip 403 shows a human interpreting the sign language in order to make the process more natural for the user 207.

The web server 201 can be accessed through any network connection, be it the Internet or any other type of network, including local networks, so that the system 200 can be provided in a first modality in the form of software-as-a-service (SaaS) or in a second modality such as on-premise.

In one embodiment of the invention, the user 207 has the possibility of changing the position of the video clip within the screen of the electronic device 206 simply by dragging and dropping it in any place of preference with the help of the mouse.

Also, the user 207 can access a help menu 501 within the system 200 that will instruct how to use the system 200 and method 100 of the present invention. In the illustrated embodiment, the help menu is activated and deactivated 111 by pressing the F1 key on a keyboard associated with the electronic device 206. FIG. 5 shows the help menu that is displayed 112 when pressing the F1 key in the example modality.

Since the system 200 also includes an artificial intelligence module 203 coupled to the knowledge database 202, the system 200 is capable of learning and enriching the knowledge database 202 autonomously, also using the context of the URL in order to deliver accurate and reliable interpretations of the input language. The artificial intelligence module 203 comprises a neural-type network, which, based on training, analyzes a large amount of information taken from the navigations made on the URL where the system 200 operates and performs the interpretation based on the context of the information. In order to perform the interpretation based on the context, said neural network groups the dictionaries according to the main topic of the URL visited by the user 207 (for example, politics, science and technology, news, etc.) and also by language, since the present invention is not limited to Spanish or its associated sign language, but can be applied to any other language and its corresponding sign language (English, French, Portuguese, German, to name a few examples). To select the Web page language, the present invention has a geolocation tool that allows identifying the region from which the user 207 accesses the website provided with the system 200. Dictionary selection based on the context of the web basically uses an automatic selection algorithm that recognizes a specific pattern in the language thanks to previously performed analysis and grouping steps, at the same time that it groups the new words identified according to the topic they deal with and adds them to the knowledge database 202, thus enriching the database 202. Once the dictionary to be applied is selected based on the web context, the artificial intelligence module 203 selects from a library of video clips with sign languages at least one video clip that corresponds to the word or text to be interpreted. Additionally, the service layer of the system 200 performs a validation of the URL sites associated with the present invention and belonging to a certain category, which allows restricting the scope of the automatic dictionary selection algorithm since, frequently, Web page content is of great variety and is found in different languages. Therefore, the Web server 201 allows a pre-analysis of the dictionary to be applied in those cases, in order to provide a much more accurate and reliable translation of the content into visual language.

The method 100 and system 200 of the present invention allow users 207 to access information that they could not otherwise consult, which allows them to obtain better living conditions, for example, by training to obtain a better job, learn new topics, pay for services or purchase products online, etc., in a simple, intuitive way and without using devices or equipment other than conventional ones, e.g., an electronic device with a network connection and an input device is enough, as detailed above.

In order to implement the system 200 of the present invention on any website, it is necessary to comply with a series of guidelines in its programming, in accordance with the recommendations of the W3C and its web content accessibility guidelines (WCAG), some of which are listed below:
URL: Use a domain name and not the IP, both for security and to avoid conflicts with redirects.
ID: Use an ID for each unique and unrepeatable element.
Website organization: syntax must be validated, using consistent headings, lists and structures. Preferably they have a layout and for every opening HTML tag there is a closing one, to avoid conflicts, as well as to avoid the use of tags without any type of content. The site must have a title defined with the <title> tag summarizing the content or function of the page. In general, the website must be correctly structured using the HTML tags that define the structure of a page, such as: <title>, <h1>, <h2>, . . . , <ul>, <ol>, <p>, <blockquote>, etc. Tables should not be used, as they hinder site accessibility. Nor should images be included within the titles.
Avoid use of hard return breaks on the site, as well as multimedia elements. If used, subtitles and transcripts of the audio files must be provided, as well as descriptions of the videos, without using videos from other domains and/or third-party players. Also avoid use of FLASH and PDF files within the site.
Avoid using images with text because the content will not be accessible for reading.
Avoid the use of alerts or pop-up windows, which can make it difficult to navigate within the site.

Of course, as a person skilled in the art will understand, there are other guidelines and recommendations for web page accessibility that can also be applied to the websites likely to implement the invention of the present invention, marked by authorities specialized in the matter, including those mentioned above.

Unless previously defined herein, the terms and expressions used herein should be understood in the normal sense given to these terms and expressions with respect to the respective areas of study thereof, except, as mentioned above, in those defined above. Relationship terms such as above, below, first, second, and the like can only be used to distinguish one entity or action from another, without the need to necessarily imply such a current relationship or request between such entities or actions. The terms “comprises”, “includes” “contains” or any other variant thereof are intended to make a non-exclusive inclusion such that a process, method, article, system, device or product comprising a list of elements not only includes those elements but may also include other elements which are not expressly listed or inherent to the process, method, article, system, device or product. The brief description of the invention is provided to acquaint the reader with the technical nature of the description. While the above description has been described with the best modalities and/or other examples, it is understood that various modifications may apply or can be made to it and that the subject matter described herein can be implemented in various forms and examples, and that such concepts can be carried out in different applications, some of which have been described above. The following claims are intended to claim any and all applications, modifications and variations that fall within the scope of the concepts herein.

1. A method for making websites accessible to users with any type of hearing impairment, the method comprising the steps of:
receiving an input language to be transformed into an output language by an input device, wherein the input language is in the form of text or words;
transmitting the input language to a web server coupled to a knowledge database to interpret the input language to the output language; and,
reproducing the output language in visual form.

2. The method for making websites accessible to users with any type of hearing impairment of claim 1, wherein the input device is selected from a mouse, an alphanumeric keyboard, a joystick, a touchpad, a light pen and similar devices and wherein the output language is preferably sign language related to the website language.

3. The method for making websites accessible to users with any type of hearing impairment of claim 2, wherein the input device is a mouse and wherein the input language is selected by the user by positioning the mouse pointer over said input language.

4. The method for making websites accessible to users with any type of hearing impairment of claim 1, wherein the knowledge database comprises a plurality of dictionaries in the language of the URL site and the sign language related to said language to interpret the input language to the output language.

5. The method for making websites accessible to users with any type of hearing impairment of claim 4, wherein before interpreting the input language there is a step of identifying the region from which the user accesses the URL site by means of a geolocation tool in order to select the dictionary to apply.

6. The method for making websites accessible to users with any type of hearing impairment of claim 1, wherein the output language is reproduced in the form of a video clip.

7. The method for making websites accessible to users with any type of hearing disability of claim 6, wherein the video clip is preferably in GIF format and wherein the video clip shows a human being interpreting sign language.

8. The method for making websites accessible to users with any type of hearing impairment of claim 1, further comprising a step of autonomous selection and enrichment of the knowledge database.

9. The method for making websites accessible to users with any type of hearing impairment of claim 8, wherein the step of autonomous selection and enrichment of the knowledge database comprises:
making an analysis of massive amounts of information taken from previous navigations of the URL site;
grouping the knowledge database dictionaries according to a contextual framework comprising i) the main subject of the URL site and ii) the language of the URL site;
automatically selecting the dictionary to apply for the interpretation based on the context;
adding the newly identified words to the knowledge database; and,
selecting from a sign language video clip library at least one video clip that corresponds to the word/text to be interpreted.

10. The method for making websites accessible to users with any type of hearing impairment of claim 9, wherein before selecting the dictionary to apply, a pre-analysis of said dictionary is performed to provide a more accurate and reliable interpretation of the input language to the output language.

11. A system for making websites accessible to users with any type of hearing disability, the system comprising at least one electronic device with a processing unit, a memory, a communication interface and an input/output interface, and a web server coupled to a knowledge database to interpret an input language to an output language;
wherein the electronic device is in communication with the web server via a communication network and wherein the electronic device is configured to:
receive an input language to be transformed into an output language by an input device, wherein the input language is in the form of text or words;
transmit the input language to the web server coupled to the knowledge database to interpret the input language to the output language in an interpretation module; and,
reproduce the output language in visual form.

12. The system of claim 11, wherein the input device is selected from a mouse, an alphanumeric keyboard, a joystick, a touchpad, a light pen and similar devices and wherein the output language is preferably sign language related the website language.

13. The system of claim 12, wherein the input device is a mouse.

14. The system of claim 11, wherein the web server coupled to the knowledge database is of the ICAP type and wherein said knowledge database comprises a plurality of dictionaries in the language of the URL site and the sign language related to that language to interpret the input language to the output language.

15. The system of claim 11, wherein the system geolocates the region from which the user accesses the URL site before interpreting the input language.

16. The system of claim 1, wherein the output language is reproduced in the form of a video clip.

17. The system of claim 16, wherein the video clip is preferably in GIF format and wherein the video clip shows a human being interpreting sign language.

18. The system of claim 11, wherein the system comprises an artificial intelligence module coupled to the knowledge database, the artificial intelligence module comprising a neural network that autonomously selects and enriches the knowledge database.

19. The system of claim 18, wherein to select and enrich the knowledge database, the neural network is configured to:
make an analysis of massive amounts of information taken from previous navigations of the URL site;
group the knowledge database dictionaries according to a contextual framework comprising i) the main subject of the URL site and ii) the language of the URL site;
automatically select the dictionary to apply for the interpretation based on the context;
add the newly identified words to the knowledge database; and,
select from a sign language video clip library at least one video clip that corresponds to the word/text to be interpreted.

20. The system of claim 19, wherein before selecting the dictionary to apply, the web server performs a pre-analysis of the dictionary to provide a more precise and reliable interpretation of the input language to the output language.
